(19) United States
(12) Patent Application Publication
(10) Pub. No.: US 2025/0182735 A1
(43) Pub. Date: Jun. 5, 2025

(54) Opposed Driver Toroidal Compression Horn System and Method of Use

(71) Applicant: Russel Lerch, Nazareth, PA (US)

(72) Inventor: Russel Lerch, Nazareth, PA (US)

(21) Appl. No.: 18/918,340

(22) Filed: Oct. 17, 2024

Related U.S. Application Data
(60) Provisional application No. 63/606,167, filed on Dec. 5, 2023.

(51) Int. Cl. G10K 13/00

(52) U.S. Cl. CPC G10K 13/00

(57) ABSTRACT

A toroidal compression horn device designed to generate a toroidal wavefront, thereby creating a 360-degree sound field for a natural and immersive audio experience is disclosed. The device includes a first and a second compression driver, each with a precision-machined aluminum faceplate featuring a central aperture. The drivers are bolted together (i.e., connected) with a precise gap forming a compression throat and are wired in phase to operate in unison, thereby generating compression and expansion actions. The assembly is positioned between two convex discs that shape the sound waves into a toroidal pattern and provide damping to reduce unwanted resonances. A frame encloses the components, making the device portable and suitable for various applications, including loudspeakers.

### CROSS-REFERENCE TO RELATED APPLICATION

The present application claims priority to, and the benefit of, U.S. Provisional Application No. 63/606,167, which was filed on Dec. 5, 2023, and is incorporated herein by reference in its entirety.

### FIELD OF THE INVENTION

The present invention generally relates to the field of audio reproduction devices. More specifically, the present invention relates to a novel toroidal compression horn device designed to generate a toroidal wavefront, creating a 360-degree sound field for a natural and immersive audio experience. The toroidal compression horn device includes a first and a second compression driver, each with a precision-machined aluminum faceplate featuring a central aperture. These drivers are bolted together with a precise gap forming a compression throat and are positioned between two convex discs that shape the sound waves. The device also includes a high and low frequency design, making it portable and suitable for various applications, including loudspeakers and headphones. Accordingly, the present disclosure makes specific reference thereto. Nonetheless, it is to be appreciated that aspects of the present invention are also equally applicable to other like applications, devices, and methods of manufacture.

### BACKGROUND

By way of background, sound is naturally produced in all directions simultaneously, creating a cohesive auditory experience. However, when highly directional units, such as traditional loudspeakers, are used, the resulting sound can appear unnatural to the human ear. As traditional loudspeakers focus sound on specific directions, they disrupt the natural omnidirectional propagation of sound waves. When multiple loudspeakers are used to reproduce sound, the arrival times of sound waves at the listener's ear can vary, leading to a disassociated auditory experience. This disassociation can cause confusion, as the brain struggles to process and integrate the asynchronous sound signals.

Furthermore, when sound is reproduced in a non-coherent fashion such as where the wavefronts from different speakers are out of phase with each other, random cancellations and amplifications of sound waves occur. The phase discrepancies result in “coloring” of the sound, where the intended audio is altered, and the quality thereof is compromised. The random nature of these phase interactions leads to an inconsistent and often unsatisfactory listening experience. Individuals desire an innovative approach to sound reproduction that maintains the natural coherence and omnidirectional quality of sound.

Therefore, there exists a long-felt need in the art for an improved sound reproduction device that generates a natural and immersive audio experience. There is also a long-felt need in the art for a sound system that creates a 360-degree sound field. Additionally, there is a long-felt need in the art for a sound reproduction device that minimizes the unnatural directional sound produced by traditional loudspeakers. Moreover, there is a long-felt need in the art for a device that reduces phase discrepancies and prevents random cancellations and amplifications of sound waves. Further, there is a long-felt need in the art for a portable sound system that can be used in various applications, including loudspeakers and headphones. Furthermore, there is a long-felt need in the art for a sound reproduction device that integrates precision-machined components to enhance sound clarity and reduce resonances. Finally, there is a long-felt need in the art for a comprehensive solution that addresses the challenges of producing coherent, natural sound in an omnidirectional manner, improving the overall listening experience.

The subject matter disclosed and claimed herein, in one embodiment thereof, comprises an opposite toroidal (i.e., doughnut-shaped) compression horn device. The horn device comprises a first compression driver including a first faceplate with a central aperture, a second compression driver including a second faceplate with a corresponding central aperture, the first and second compression drivers being bolted together with a precise gap between their respective faceplates, forming a compression throat, a pair of convex discs positioned on either side of the drivers, wherein the convex discs shape sound waves emitted from the compression drivers into a toroidal wavefront, creating a 360-degree sound field. The device includes both high and low frequency units customized for different applications.

In this manner, the opposed driver toroidal compression horn device of the present invention accomplishes all of the foregoing objectives and provides users with a novel solution for creating a natural and immersive audio experience. The device includes a first and a second compression driver, each with a precision-machined aluminum faceplate featuring a central aperture. These drivers are bolted together with a precise gap forming a compression throat, and are wired in phase to operate in opposition, generating a compress and expand action. The assembly is positioned between two convex discs that shape sound waves into a toroidal wavefront, creating a 360-degree sound field. The device minimizes the unnatural directional sound produced by traditional loudspeakers and reduces phase discrepancies and prevents random cancellations and amplifications of sound waves, thus avoiding the coloring of sound.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a toroidal compression horn device. The horn device comprises a first compression driver including a first faceplate with a central aperture, a second compression driver including a second faceplate with a corresponding central aperture, the first and second compression drivers being bolted together with a precise gap between their respective faceplates, forming a compression throat, a pair of convex discs positioned on either side of the drivers, wherein the convex discs shape sound waves emitted from the compression drivers into a toroidal wavefront, creating a 360-degree sound field.

In yet another embodiment, a toroidal compression horn device is disclosed. The device includes a first compression driver including a first faceplate with a central aperture, a second compression driver including a second faceplate with a corresponding central aperture, the first and second compression drivers are wired in phase, such that when the first compression driver compresses air, the second compression does also, thereby simultaneously generating compression and expansion actions for creating the toroidal (i.e., doughnut-shaped) wavefront, a first convex disc positioned above the first compression driver, and a second convex disc positioned below the second compression driver.

In another embodiment, the horn devices can be stacked. The discs or cones forming the horn have a precise opening in their centers to position the driver bodies, thereby making the horn device portable and suitable for various applications.

In still another embodiment, the first and second faceplates are made of precision-machined aluminum and are firmly attached to their respective compression drivers using a plurality of fasteners.

In another aspect, the compression drivers have a frequency response range of 20 Hz to 20 kHz, enabling for the accurate reproduction of mid and high frequencies.

In yet another aspect, the convex discs forming the horn are bolted together securely, thereby forming tension on the driver assembly holding it securely in place. The drivers are contained in machined openings in the convex horn and are held by a clamping mechanism.

In another embodiment, a method for operating using a toroidal compression horn device is disclosed. The method includes the steps of wiring a first compression driver and a second compression driver in phase with each other, providing a first faceplate with a central aperture on the first compression driver, providing a second faceplate with a corresponding central aperture on the second compression driver, bolting the first and second compression drivers together with a precise gap between their respective faceplates, forming a compression throat, positioning a first convex disc above the first compression driver and a second convex disc below the second compression driver, operating the first and second compression drivers in opposition to create compression and expansion actions, sending a toroidal wavefront into the surrounding air through the horn device, shaping the sound waves emitted from the compression drivers into a toroidal wavefront using the first and second convex discs, and creating an omnidirectional sound field, providing consistent audio quality in all directions.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of opposed driver toroidal compression horn device of the present invention in accordance with the disclosed structure;

FIG. 2 illustrates a perspective view of the low frequency opposed driver toroidal compression horn device of the present invention enclosed in a frame in accordance with the disclosed structure;

FIG. 3 illustrates a top view of a compression driver of the horn device of the present invention in accordance with the disclosed structure; and

FIG. 4 illustrates a flow chart depicting a process of operation of the horn device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved sound reproduction device that generates a natural and immersive audio experience. There is also a long-felt need in the art for a sound system that creates a 360-degree sound field. Additionally, there is a long-felt need in the art for a sound reproduction device that minimizes the unnatural directional sound produced by traditional loudspeakers. Moreover, there is a long-felt need in the art for a device that reduces phase discrepancies and prevents random cancellations and amplifications of sound waves. Further, there is a long-felt need in the art for a portable sound system that can be used in various applications, including loudspeakers and headphones. Furthermore, there is a long-felt need in the art for a sound reproduction device that integrates precision-machined components to enhance sound clarity and reduce resonances. Finally, there is a long-felt need in the art for a comprehensive solution that addresses the challenges of producing coherent, natural sound in an omnidirectional manner, improving the overall listening experience.

The present invention, in one exemplary embodiment, is a method for operating using a toroidal compression horn device. The method includes the steps of wiring a first compression driver and a second compression driver in phase with each other, providing a first faceplate with a central aperture on the first compression driver, providing a second faceplate with a corresponding central aperture on the second compression driver, fastening the first and second compression drivers together with a precise gap between their respective faceplates, forming a compression throat, operating the first and second compression drivers in unison to create compression and expansion actions, sending a toroidal wavefront into the surrounding air through the horn device, shaping the sound waves emitted from the compression drivers into a toroidal wavefront using the first and second convex discs.

Reference will now be made in detail to the present preferred embodiments of the invention, examples of which are illustrated in the accompanying drawings. Wherever possible, the same reference numerals are used in the drawings and the description to refer to the same or like parts.

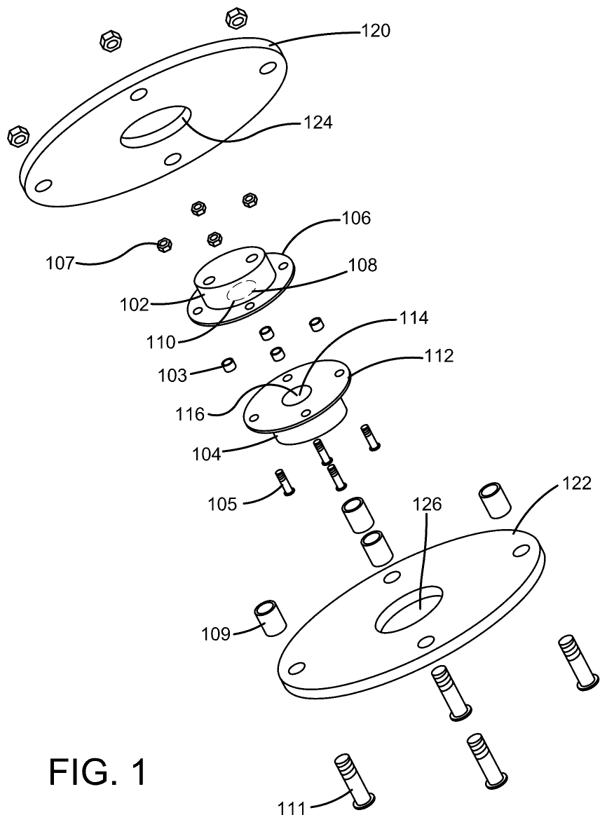

Referring initially to the drawings, FIG. 1 illustrates a perspective view of opposed driver toroidal compression horn device of the present invention in accordance with the disclosed structure. The opposed driver toroidal compression horn device 100 of the present invention is designed to generate a toroidal wavefront, creating a 360-degree sound field, resulting in a natural and immersive audio experience. More specifically, the horn device 100 includes a first compression driver 102 and an identical second compression driver 104. The compression drivers 102, 104 are used for compressing sound waves. The first compression driver 102 includes a faceplate 106 attached and disposed thereon which is preferably made of aluminum and is firmly attached to the compression driver 102 using a plurality of fasteners 107. The faceplate 106 includes an aperture 108 at the center 110 thereof enabling the sound waves to pass therethrough. The second compression driver 104 includes a faceplate 112 separated by spacers and disposed thereon which can also be made of aluminum and includes a corresponding aperture 114 at the center 116 thereof. The sound waves also pass through the aperture 114 of the second compression driver 104.

The compression drivers 102, 104 are bolted together with a precise gap between their faceplates 106, 112 which form a compression throat 118 therebetween. The size and shape of the compression throat 118 can be designed based on size of the horn device 100. The assembly of the compression drivers or units 102, 104 is positioned between the two convex discs 120, 122, including spacers 109 and bolts 111. The first disc 120 is positioned above the first compression driver 102 and the second disc 122 is positioned below the second compression drive 104. It will be apparent to a person skilled in the art that the discs 120, 122 are located on either side of the compression drivers 102, 104 and help to shape the sound waves into a toroidal shape. The discs 120, 122 dampen the vibrations of the compression units 102, 104 to reduce unwanted resonances and the toroidal shape helps direct the sound waves. It is to be appreciated that the design of the compression assembly self-cancels vibration. The toroidal wavefront creates an omnidirectional sound field, providing consistent audio quality in all directions and the device 100 produces a sound that is more natural and pleasing to the human car, as opposed to traditional directional loudspeakers. The discs 120, 122 also include the apertures or holes 124, 126 for mounting compression drivers 102, 104, respectively, for enabling the sound from the compression drivers 102, 104 to release to a hearing zone.

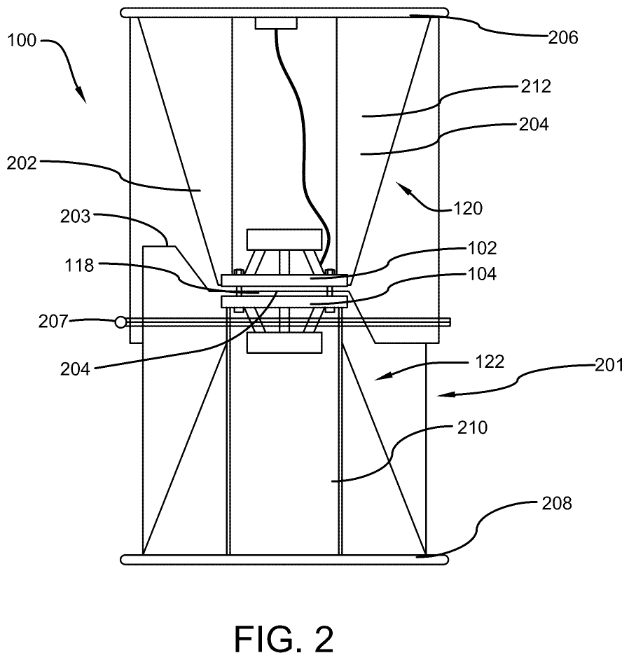

FIG. 2 illustrates a perspective view of the opposed driver toroidal compression horn device of the present invention enclosed in a frame in accordance with the disclosed structure. The horn device 100 is portable and can be used for different uses such as addressing individuals, listening to songs, and more. The device 100 can also be designed as headphones, loudspeakers, and more. As illustrated, the device 100 includes a frame or low frequency unit 201 including a pair of walls or fins 202, 204, a top wall 206, and a bottom wall 208; including a clamp 207 on the fins 202, 204. The frame 201 forms a sealed enclosure for the components of the horn device 100 illustrated in FIG. 1.

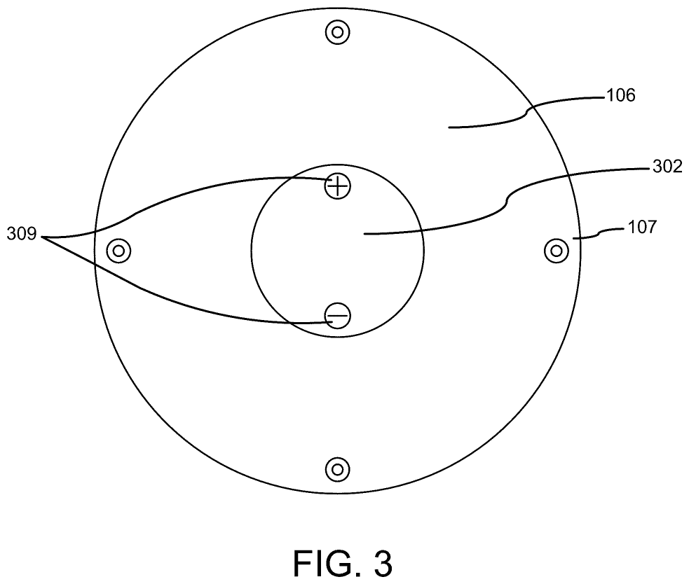

As illustrated, the compression drivers 102, 104 are bolted using fasteners 203 and are supported by the convex discs 120, 122, respectively. The discs 120, 122 help in creating the toroidal cone or wavefront 212 for providing 360-degrees effect and dampening the low frequency (i.e., sound waves) 210. The faceplates of the drivers 102, 104 also have small overhanging flange for providing a rigid connection as illustrated in FIG. 3.

FIG. 3 illustrates a top view of a compression driver 302 of the horn device of the present invention in accordance with the disclosed structure. As illustrated, the faceplate 106 of the driver 102 is fastened using fasteners 107 and overlaps the driver 102. Further, the faceplates 106, 112 include bolts 105 and spacers 103 therebetween for providing secure connection between the faceplates of drivers 102, 104 (refer to FIG. 1). The driver 302 includes electrical terminals 309.

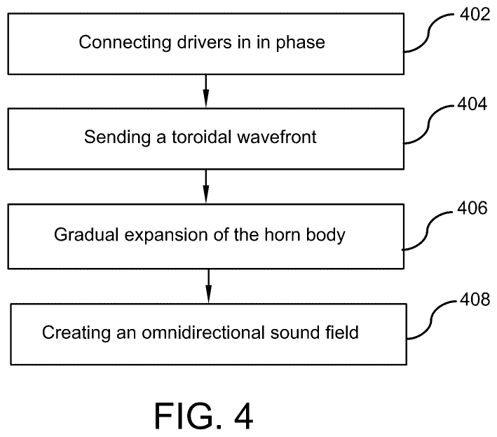

FIG. 4 illustrates a flow chart depicting a process of operation of the horn device of the present invention in accordance with the disclosed structure. Initially, the two drivers 102, 104 are wired in phase with each other such that when the first driver 102 compresses air, the second driver 104 also compresses the air and vice versa (Step 402). As the drivers 102, 104 operate in opposition, the drivers 102, 104 create a compression and expansion action for sending a toroidal wavefront into the surrounding air through the horn 100 (Step 404). The toroidal wavefront provides gradual expansion of the horn body ensuring that the drivers are unidirectionally coupled to the air around them (Step 406). Finally, the toroidal wavefront creates an omnidirectional sound field, providing consistent audio quality in all directions (Step 408).

The drivers 102, 104 can be made of die-cast aluminum and the faceplates 106, 112 are made of precision-machined aluminum. The drivers 102, 104 have high damping factor to reduce resonance and provide clear sound quality. The frequency response of the drivers 102, 104 can be in the range 20 Hz-20 kHz. The wide frequency range enables the drivers 102, 104 to reproduce both mid and high frequencies accurately.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “toroidal compression horn device for generating omnidirectional sound fields”, “opposed driver toroidal compression horn system”, “opposed driver toroidal compression horn device”, and “horn device” are interchangeable and refer to the opposed driver toroidal compression horn system 100 of the present invention.

Notwithstanding the forgoing, the opposed driver toroidal compression horn system 100 of the present invention can be of any suitable size and configuration as is known in the art without affecting the overall concept of the invention, provided that it accomplishes the above stated objectives. One of ordinary skill in the art will appreciate that the opposed driver toroidal compression horn system 100 as shown in the FIGS. are for illustrative purposes only, and that many other sizes and shapes of the opposed driver toroidal compression horn system 100 are well within the scope of the present disclosure. Although the dimensions of the opposed driver toroidal compression horn system 100 are important design parameters for user convenience, the opposed driver toroidal compression horn system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A toroidal compression horn device comprising:
a first compression driver having a first faceplate;
a second compression driver having a second faceplate;
a first convex disc; and
a second convex disc;
wherein said first compression driver compressing a first sound wave;
wherein said second compression driver compressing a second sound wave simultaneously;
wherein said first faceplate having a first aperture;
wherein said second faceplate having a second aperture; and
further wherein said first compression driver connected to said second compression driver with a gap between said first faceplate and said second faceplate for generating a toroidal wavefront.

2. The toroidal compression horn device of claim 1, wherein said toroidal wavefront having an omnidirectional sound field.

3. The toroidal compression horn device of claim 1, wherein said first faceplate and said second faceplate having a material of aluminum.

4. The toroidal compression horn device of claim 1, wherein said first sound wave and said second sound wave passes through said first aperture and said second aperture.

5. The toroidal compression horn device of claim 4, wherein said gap forming a compression throat.

6. The toroidal compression horn device of claim 5, wherein said first convex disc positioned above said first compression driver, and further wherein said second convex disc positioned below said second compression driver.

7. The toroidal compression horn device of claim 6, wherein said first convex disc having a first disc aperture and said second convex disc having a second disc aperture for releasing said first sound wave and said second sound wave to a hearing zone.

8. The toroidal compression horn device of claim 7, wherein said toroidal compression horn device is selected from the group consisting of a headphone and a loudspeaker.

9. The toroidal compression horn device of claim 8 further comprising a frame, wherein said frame having a pair of cylindrical walls, a top wall, and a bottom wall surrounding said toroidal compression horn device.

10. The toroidal compression horn device of claim 9, wherein said frame is a sealed enclosure for enclosing said toroidal compression horn device.

11. The toroidal compression horn device of claim 10, wherein said first faceplate having an overhanging flange for providing secure connection between said first faceplate and said first convex disc.

12. A toroidal compression horn device comprising:
a first compression driver having a first faceplate;
a second compression driver having a second faceplate;
a first convex disc; and
a second convex disc;
wherein said first compression driver compressing a first sound wave;
wherein said second compression driver compressing and combining a second sound wave simultaneously;
wherein said first faceplate having a first aperture;
wherein said second faceplate having a second aperture; and
further wherein said first compression driver and said second compression driver are wired in phase with each other such that when said first compression driver compresses air, said second compression driver compresses air simultaneously.

13. The toroidal compression horn device of claim 12, wherein said first compression driver and said second compression driver operate in opposition for creating a compression of air and an expansion of air.

14. The toroidal compression horn device of claim 12, wherein said first faceplate and said second faceplate having a material of aluminum.

15. The toroidal compression horn device of claim 12, wherein said first sound wave and said second sound wave passes through said first aperture and said second aperture; and
further wherein said first sound wave and said second sound wave combine in a compression throat.

16. The toroidal compression horn device of claim 15, wherein said first compression driver connected to said second compression driver with a gap between said first faceplate and said second faceplate for generating a toroidal wavefront, and further wherein said gap forming said compression throat.

17. The toroidal compression horn device of claim 12, wherein said first convex disc positioned above said first compression driver, and further wherein said second convex disc positioned below said second compression driver.

18. The toroidal compression horn device of claim 17, wherein said first convex disc having a first disc aperture and said second convex disc having a second disc aperture for releasing said first sound wave and said second sound wave to a hearing zone.

19. The toroidal compression horn device of claim 18, wherein said toroidal compression horn device is selected from the group consisting of a loudspeaker.

20. A toroidal compression horn device comprising:
a first compression driver having a first faceplate;
a second compression driver having a second faceplate;
a first convex cone; and
a second convex cone;
wherein said first compression driver compressing a first sound wave;
wherein said second compression driver compressing a second sound wave;
wherein said first faceplate having a first aperture;
wherein said second faceplate having a second aperture;
wherein said first compression driver and said second compression driver are wired in phase with each other such that when said first compression driver compresses air, said second compression driver compresses air for combining into a toroidal wavefront; and
further wherein said first compression driver and said second compression driver having a frequency range from 20 Hz to 20 KHz.
